(19) United States
(12) Patent Application Publication
(10) Pub. No.: US 2012/0305862 A1
(43) Pub. Date: Dec. 6, 2012

(54) WATER-BASED PRIMER COMPOSITIONS AND COATING METHODS USING THE SAME

(76) Inventors: Naoko Kasahara, Hiratsuka-shi (JP); Hideaki Katsuta, Amagasaki-shi (JP); Yasuhiro Tomizaki, Ohta-ku (JP); Kazutaka Ogura, Miyoshi-shi (JP); Hiroshi Murata, Miyoshi-shi (JP); Hironori Tonomura, Miyoshi-shi (JP)

(21) Appl. No.: 13/577,006

(22) PCT Filed: Feb. 3, 2011
(86) PCT No.: PCT/JP2011/052257

§ 371 Date: Aug. 3, 2012

(30) Foreign Application Priority Data
Feb. 5, 2010 (JP) 2010-024654

(51) Int. Cl. H01B 1/12; B05D 1/36

(52) U.S. Cl. 252/519.33; 427/470

(57) ABSTRACT

This invention provides a water-based primer composition comprising (A) an aqueous dispersion of modified polyolefin, (B) an aqueous urethane resin and/or aqueous acrylic resin, (C) a pyrazole-blocked polyisocyanate compound and (D) an electrically conducting pigment, its (C) pyrazole-blocked polyisocyanate compound content being within a range of 5-50 mass % based on the total solid content of the components (A), (B) and (C), said electrically conducting pigment (D) containing an electrically conducting metal oxide (D-1), and the content of the electrically conducting pigment (D) being within a range of 50-200 mass parts per 100 mass parts of the total solid resin content in the composition; and also methods for coating plastic shaped articles using the composition.

### TECHNOLOGICAL FIELD

This invention relates to water-based primer compositions which can impart to plastic shaped articles such as car bumpers coating colors of high value or high chroma, have sufficient electrical conductivity, and form primer coating films excelling in physical properties such as water resistance and adhesiveness even when they are thick; and also to coating methods using the compositions.

### BACKGROUND ART

Plastic materials used for car bumpers and the like generally have a surface resistivity no less than about 10¹⁰Ω/□, and it is difficult to directly coat such plastic shaped articles with paint by electrostatic coating method. Conventionally, therefore, surfaces of such materials are first coated with an electrically conducting primer and a top coat for coloring is applied thereon by an electrostatic coating method (see, for example, Patent Documents 1).

Such plastic materials are usually deeply colored, e.g., in black, and when application of a pale color top coat or that of low hiding power is intended, it is necessary to use an electrically conducting primer having high hiding power or high value color. Hence, various electrically conducting paints using electrically conducting fillers of relatively high value have heretofore been proposed (see, for example, Patent Documents 2, 3 and 4).

Where a water-based paint is used as an electrically conducting paint for safety, sanitation and environmental preservation, it becomes necessary to use a large amount of an emulsifier for dispersing in water an aqueous resin dispersion of, e.g., chlorinated polyolefin which is usually used as a vehicle component, and the water-based primer blended with such an aqueous dispersion is apt to form a coating film of insufficient water resistance, moisture resistance and the like. In particular, when the film is baked at such low temperatures not higher than 90° C., there rises a problem that the coating film tends to show low water resistance, moisture resistance and gasohol resistance during thick film formation.

With the view to solve the above problem, Patent Document 5 has proposed a water-based primer formulated by blending an aqueous dispersion of modified polyolefin, aqueous urethane resin and/or aqueous acrylic resin, and specific electrically conducting material, in combination.

However, in such occasions as wet-on-wet electrostatic application of a water-based non-conductive coloring base coat, in particular, sequential electrostatic coating of a water-based, non-conductive white base coat and a water-based iridescent base coat for white pearlescent finish, after coating the above water-based primer, there are the cases wherein the conductivity drops after application of the white base coat and satisfactory finish does not result. Whereas, an increase in the amount of the conductive filler in the water-based primer in an attempt to secure the necessary conductivity gives rise to a problem of decrease in the water resistance of the resultant multilayer coating film.

### PRIOR ART DOCUMENTS

### Patent Documents

Patent Document 1: JP 6 (1994)-165966A
Patent Document 2: JP 9 (1997)-12314A
Patent Document 3: JP 10 (1998)-53417A
Patent Document 4: JP 2006-219521A
Patent Document 5: JP 2009-30020A

### SUMMARY OF THE INVENTION

### Problems to be Solved by the Invention

An object of the invention is to provide water-based primer compositions which can impart to plastic shaped articles such as car bumpers coating colors of high value or high chroma, have sufficient electric conductivity, and form primer coating films excelling in physical properties such as water resistance and adhesiveness even when they are thick.

A further object of the invention is to provide a coating method which enables formation of multilayer coating films excelling in water resistance and finished effect, with use of such compositions.

### Means for Solving Problems

This invention provides a water-based primer composition comprising (A) an aqueous dispersion of modified polyolefin, (B) an aqueous urethane resin and/or aqueous acrylic resin, (C) a pyrazole-blocked polyisocyanate compound and (D) an electrically conducting pigment,

its (C) pyrazole-blocked polyisocyanate compound content being within a range of 5-50 mass % based on the total solid content of the components (A), (B) and (C) and

said electrically conducting pigment (D) containing (D-1) an electrically conducting metal oxide, the content of the electrically conducting pigment (D) being within a range of 50-200 mass parts per 100 mass parts of the total solid resin content in the composition.

The invention furthermore provides a coating method which comprises coating the water-based primer composition onto a plastic substrate surface, and then coating the coated surface with a top coat by electrostatic coating method.

### Effect of the Invention

Use of the water-based primer composition of the invention enables formation of primer coating film having sufficient electric conductivity and excelling in water resistance, adhesiveness and the like even when it is thick, and it becomes possible to form multilayer coating film excelling in finished effect even when a water-based non-conductive coloring base coat is applied onto so formed primer coating film wet-on-wet by electrostatic coating method.

Hereinafter the water-based primer compositions and the coating method using the same are explained in further details.

### EMBODIMENTS FOR WORKING THE INVENTION

### (A) Aqueous Dispersion of Modified Polyolefin

The modified polyolefin used in (A) aqueous dispersion of modified polyolefin normally encompasses unsaturated carboxylic acid- or the acid anhydride-modified polyolefins, acrylic-modified polyolefins, chlorinated polyolefins, and polyolefins modified by these modification means in combination. Of those, unsaturated carboxylic acid- or the acid anhydride-modified polyolefins (i) are particularly preferred.

Said unsaturated carboxylic acid- or the acid anhydride-modified polyolefin (i) is normally obtained by (co)polymerizing one or more olefins selected from C₂₋₁₀, in particular, C₂₋₄ olefins, such as ethylene, propylene, butylene, hexene and the like; and modifying the resulting polyolefin by graft copolymerizing therewith an unsaturated carboxylic acid such as (meth)acrylic acid, maleic acid, fumaric acid, itaconic acid and the like or an acid anhydride thereof, by a means known per se. In particular, those modified with maleic acid or anhydride thereof are preferred. Suitable graft copolymerization ratio with the unsaturated carboxylic acid or anhydride thereof is generally within a range of 1-20 mass %, preferably 1.5-15 mass %, inter alia, 2-10 mass %, to the solid mass of the polyolefin.

As the polyolefins to be used for preparation of unsaturated carboxylic acid- or the acid anhydride-modified polyolefins (i), those prepared with the use of single site catalyst as the polymerization catalyst are particularly preferred, because of their narrow molecular weight distribution and excellent random copolymerizability. Single site catalyst refers to the catalysts whose active sites are identical (single site). Of these single site catalysts, metallocene catalysts are particularly preferred. Metallocene catalysts are normally prepared by combining metallocene (bis(cyclopentadienyl) metal complex and derivatives thereof) which are compounds of Groups IV-VI and VIII transition metals or of Group III rare earth transition metals of periodic table, having at least one conjugated 5-membered ring ligand per molecule; a promoter which can activate metallocene, such as aluminoxane or the like; and an organoaluminium compound such as trimethylaluminum. Preparation of such a polyolefin can be performed by a method known per se, for example, by supplying such an olefin as propylene or ethylene and hydrogen into a reactor, while continuously adding thereinto an alkylaluminum and metallocene catalyst.

Those unsaturated carboxylic acid- or the acid anhydride-modified polyolefin (i) may be further acrylic-modified, where necessary. Examples of the polymerizable unsaturated monomer useful for the acrylic modification include alkyl esters of (meth)acrylic acid such as methyl(meth)acrylate, ethyl(meth)acrylate, n- or i-propyl(meth)acrylate, n-, i-, or t-butyl(meth)acrylate, 2-ethylhexyl(meth)acrylate, cyclohexyl(meth)acrylate, lauryl(meth)acrylate and stearyl(meth)acrylate; (meth)acrylic monomers such as (meth)acrylic acid, glycidyl(meth)acrylate, 2-hydroxyethyl(meth)acrylate, (meth)acrylamide, and (meth)acrylonitrile; and styrene. These can be used either alone or as a mixture of two or more.

In this specification, “(meth)acrylic” means acrylic or methacrylic, and “(meth)acrylate” means acrylate or methacrylate.

As the acrylic modification method, for example, there is one comprising first introducing polymerizable unsaturated groups into the unsaturated carboxylic acid- or the anhydride-modified polyolefin (i) through reaction of the polyolefin with (meth)acrylic unsaturated monomer reactive with the carboxyl groups in the modified polyolefin, such as glycidyl(meth)acrylate, 2-hydroxyethyl(meth)acrylate and the like; and successively copolymerizing the resultant unsaturated carboxylic acid- or the acid anhydride-modified polyolefin into which the polymerizable unsaturated groups have been introduced, with one or more other polymerizable unsaturated monomer(s). Use ratio of said polymerizable unsaturated monomer useful in the occasion of such acrylic modification is desirably not more than 85 mass % in general and in total, in particular, within a range of 0.1-80 mass %, based on the solid mass of the resulting modified polyolefin, in respect of compatibility with other components and adhesiveness of the formed coating film.

Those unsaturated carboxylic acid- or the acid anhydride-modified polyolefins (i) may be further chlorinated, where necessary. Or the modified polyolefin may be a chlorinated polyolefin. The chlorination can be performed, for example, by blowing chlorine gas into an organic solvent solution or dispersion of the polyolefin or modified polyolefin (i), at reaction temperatures normally ranging 50-120° C. The chlorine content of so chlorinated polyolefin or modified polyolefin (as solid) is variable according to the properties desired for the chlorinated polyolefin or modified polyolefin (i). In respect of adhesiveness of eventually formed coating film, it is desirable that the chlorine content is generally not more than 35 mass %, in particular, within a range of 10-30 mass %, inter alia, 12-25 mass %, based on the mass of chlorinated polyolefin or modified polyolefin (i).

It is convenient that such polyolefins to be used for the unsaturated carboxylic acid- or the acid anhydride-modified polyolefin (i) contain, in particular, propylene as a polymerization unit. The mass ratio of propylene unit in the polyolefin used for the unsaturated carboxylic acid- or the acid anhydride-modified polyolefin (i) generally conveniently ranges 0.5-0.99, in particular, 0.6-0.97, inter alia, 0.7-0.95, in respect of compatibility with other components and adhesiveness of the coating film formed.

The unsaturated carboxylic acid- or the acid anhydride-modified polyolefin (i) can have a melting point generally not higher than 120° C., preferably within a range of 50-110° C., inter alia, 50-100° C.; and a mass-average molecular weight (Mw) generally within a range of 30,000-200,000, preferably 40,000-175,000, inter alia, 50,000-150,000. When the melting point and/or mass-average molecular weight (Mw) of the modified polyolefin (i) deviate from the above range(s), the objects of the invention cannot be accomplished, occasionally producing undesirable result such as reduction in compatibility with other components or interlayer adhesion between the formed coating film and the polyolefin substrate or top coating film layer. In respect of such adhesiveness, it is desirable that the modified polyolefin (i) has a heat of fusion within a range of generally 1-50 mJ/mg, in particular, 2-50 mJ/mg, inter alia, 3-50 mJ/mg.

Here the melting point and heat of fusion are the values determined by measuring the heat quantity at −100° C. to 150° C. under a temperature rise rate of 10° C./min., with “DSC-5200” (tradename, Seiko Instruments & Electronics), per 20 mg each of the modified polyolefins.

Melting point of the modified polyolefin (i) can be adjusted by varying composition of the polyolefin, in particular, by varying the quantity of α-olefin monomer. When it is difficult to determine the heat of fusion of a test sample, the heat quantity can be measured by the above method after heating the sample to 120° C., cooling the same at a rate of 10° C./min. and allowing it to stand for at least for the following 2 days.

The mass-average molecular weight of the modified polyolefin (i) is the value obtained by measuring the retention time (retention capacity) of the test sample with gel permeation chromatograph (GPC) and converting the measured value to the molecular weight of polystyrene, based on the retention time (retention capacity) of standard polystyrene whose molecular weight is known and whose retention time is measured under identical conditions. In these occasions, “HLC/GPC 150C” (Water Co., 60 cm×1) was used as the gel permeation chromatographing device, at the column temp. of 135° C., using o-dichlorobenzene as the solvent under a flow rate of 1.0 ml/min. Each sample fed was formulated by dissolving a sample polyolefin for 1-3 hours at 140° C., to attain a concentration of 5 mg polyolefin/3.4 ml of o-dichlorobenzene. As a column useful in the gel permeation chromatography, “GMH_{HR}-H(S)HT” (tradename, Tosoh Corp.) may be named.

Suitable unsaturated carboxylic acid- or the acid anhydride-modified polyolefin (i) has a ratio of mass-average molecular weight to number-average molecular weight (Ww/Mn) generally within a range of 1.5-4.0, in particular, 1.75-3.75, inter alia, 2.0-3.5, in respect of compatibility with other components and adhesiveness of the formed coating film.

The unsaturated carboxylic acid- or the acid anhydride-modified polyolefin (i) may further be modified with a compound having a polyoxyalkylene chain, for imparting thereto moisture resistance and gasohol resistance.

As examples of said polyoxyalkylene chain in the compound having polyoxyalkylene chain, polyoxyethylene chain, polyoxypropylene chain, and polyoxyethylene-polyoxypropylene blocked chain can be named.

Suitable compound having polyoxyalkylene chain has a number-average molecular weight generally within a range of 400-3,000, in particular, 450-2,500, inter alia, 500-2,000. Where the polyoxyalkylene chain-containing compound has a number-average molecular weight less than 400, it cannot fully exhibit its effect attributable to the hydrophilic group and may adversely affect performance of formed coating film (in particular, water resistance). On the other hand, when it exceeds 3,000, the compound solidifies at ambient temperature, shows aggravated solubility and becomes difficult of handling.

As such unsaturated carboxylic acid- or the acid anhydride-modified polyolefin (i) which is further modified with a compound having polyoxyalkylene chain, the particularly preferred are those obtained through a reaction of the unsaturated carboxylic acid- or the acid anhydride-modified polyolefin (i) with a compound (II) having hydroxyl or amino group at its terminus and also a polyoxyalkylene chain; and where the unsaturated carboxylic acid- or the acid anhydride-modified polyolefin (i) has been acrylic-modified, those obtained through a reaction thereof with a compound (iii) having a polymerizable unsaturated group at its terminus and also a polyoxyalkylene chain.

Examples of such compound (II) having hydroxyl or amino group at its terminus and also a polyoxyalkylene chain, which is used for modification of the unsaturated carboxylic acid- or the acid anhydride-modified polyolefin (i), include polyoxyalkylene alkyl ethers such as polyoxyethylene stearyl ether; polyoxyalkylene alkyl phenyl ethers such as polyoxyethylene nonyl phenyl ether and polyoxyethylene dodecyl phenyl ether; polyoxyalkylene fatty acid esters such as polyoxyethylene fatty acid esters; and polyoxyalkylene alkylamines such as polyoxyethylene alkylamines and ethylene oxide propylene oxide polymer adducts of alkyl aklanolamines. Those can be used either alone or in combination of two or more.

The reaction of the unsaturated carboxylic acid- or the acid anhydride-modified polyolefin (i) with such a compound (II) having hydroxyl or amino group at its terminus and also a polyoxyalkylene chain can be performed, for example, by heat-fusion of the unsaturated carboxylic acid- or the acid anhydride-modified polyolefin (i) at 80-200° C., followed by addition of a compound (II) thereto and, where necessary, of also a basic substance, and heating. In that occasion, it is desirable to use the compound (II) within a range of normally 0.5-50 mass parts, in particular, 0.5-25 mass parts, per 100 mass parts of the solid content of the modified polyolefin (i).

Examples of the compound (iii) having a polymerizable unsaturated group at its terminus and also a polyoxyalkylene chain, which is used for modification of the unsaturated carboxylic acid- or the acid anhydride-modified polyolefin (i), include polyethylene glycol(meth)acrylate, polypropylene glycol(meth)acrylate, polyoxyethylene methyl ether(meth)acrylate, polyoxypropylene methyl ether(meth)acrylate, polyoxyethylene lauryl ether(meth)acrylate, polyoxyethylene nonyl phenyl ether(meth)acrylate, polyoxyethylene lauryl ether maleic acid ester, and allyl group-containing polyoxyethylene nonyl phenyl ether. Those can be used either alone or in combination of two or more.

The reaction of the unsaturated carboxylic acid- or the acid anhydride-modified polyolefin (i) with the compound (iii) having a polymerizable unsaturated group at its terminus and also a polyoxyalkylene chain can be performed, for example, by a process comprising heat-fusing the unsaturated carboxylic acid- or the acid anhydride-modified polyolefin (i) at 80-200° C.; adding thereto a (meth)acrylic polymerizable unsaturated monomer reactable with carboxyl groups in the unsaturated carboxylic acid- or the acid anhydride-modified polyolefin, as explained earlier as to the acrylic modification, for example, glycidyl(meth)acrylate, 2-hydroxyethyl(meth)acrylate and the like; also adding, where necessary, a polymerization inhibitor or basic substance; and heating, to first introduce the polymerizble unsaturated groups into the modified polyolefin (i); then adding thereto a compound (iii) and, where necessary, polymerization initiator or the like, and heating the system to complete the reaction. In that occasion, it is desirable to use the compound (iii) within a range of normally 0.5-50 mass parts, in particular, 0.5-25 mass parts, per 100 mass parts of the solid content of the modified polyolefin (i).

An aqueous dispersion (A) of modified polyolefin is obtainable by dispersing the modified polyolefin prepared as above in an aqueous medium such as water. In that occasion, where necessary, a part or the whole of carboxyl groups in the modified polyolefin (i) may be neutralized with an amine compound and/or an emulsifier may be added. Where the modified polyolefin contains a polyoxyalkylene chain, it is possible to disperse the modified polyolefin in an aqueous medium without using such an amine compound or emulsifier, or using only a minor amount(s) thereof.

Examples of the amine compound used for the neutralization include tertiary amines such as triethylamine, tributylamine, dimethylethanolamine and triethanolamine; secondary amines such as diethylamine, dibutylamins, diethanolamine and morpholine; and primary amines such as propylamine and ethanolamine.

Desirable use rate of the amine compound is within a range of 0.1-1.0 molar equivalent to the carboxyl groups in the modified polyolefin (i).

Examples of the emulsifier include nonionic emulsifiers such as polyoxyethylene monooleyl ether, polyoxyethylene monostearyl ether, polyoxyethylene monolauryl ether, polyoxyethylene tridecyl ether, polyoxyethylene phenyl ether, polyoxyethylene nonyl phenyl ether, polyoxyethylene octyl phenyl ether, polyoxyethylene monolaurate, polyoxyethylene monostearate, polyoxyethylene monooleate, sorbitan monolaurate, sorbitan monostearate, sorbitan trioleate and poyoxyethylene sorbitan monolaurate; anionic emulsifiers such as sodium salts or ammonium salts of alkylsulfonic acid, alkyl benzenesulfonic acid and alkylphosphoric acid; polyoxyalkylene group-containing anionic emulsifiers having an anionic group and a polyoxyalkylene group such as polyoxyethylene, polyoxypropylene and the like, per molecule; and reactive anionic emulsifiers containing an anionic group as above and a polymerizable unsaturated group per molecule. They can be used either alone or in combination of two or more.

Desirable use rate of the emulsifier is normally no more than 30 mass parts, in particular, within a range of 0.5-25 mass parts, per 100 mass parts of the solid content of modified polyolefin (i).

Aqueous Urethane Resin and/or Aqueous Acrylic Resin (B)

Aqueous urethane resin (B-1) which is used in the water-based primer composition of the invention is of a water-soluble or water-dispersible resin having a urethane bond within its molecule, which is used in such forms as self-emulsifying urethane resin emulsion having an acid value, urethane resin emulsion used concurrently with an emulsifier, and water-soluble urethane resin. In particular, urethane resin in the form of a dispersion is preferred.

A urethane resin dispersion is normally obtainable by preparing a urethane prepolymer in advance through reaction of a diol with diisocyanate and, where necessary, dimethylolalkanoic acid and the like in the presence of an emulsifier, and while dispersing the urethane prepolymer in water, performing forced emulsification or self-emulsification.

Skeletal structure of the aqueous urethane resin (B-1) can be, for example, ether type, carbonate type or ester type. Of these, ether type or carbonate type are preferred in respect of water-resistance of the coating film formed. Aqueous urethane resin (B-1) may contain hydroxyl groups.

As aqueous acrylic resin (B-2) which is used in the water-based primer composition of the invention, water-soluble acrylic resin having a mass-average molecular weight within a range of 5,000-100,000, preferably 5,000-50,000, which is normally obtainable through copolymerization of a monomer mixture comprising hydrophilic group-containing polymerizable unsaturated monomer(s) such as carboxyl-containing polymerizable unsaturated monomer(s) and other polymerizable unsaturated monomer(s); and an acrylic resin emulsion having a mass-average molecular weight of at least 50,000, preferably at least 100,000 are useful. Here the mass-average molecular weight is a value obtained by converting the retention time (retention capacity) of the test sample as measured with gel permeation chromatograph (GPC) to that of molecular weight of polystyrene according to the retention time (retention capacity), as measured under identical conditions, of the standard polystyrene of known molecular weight. The retention time (retention capacity) can be measured with “HLC-8120GPC” (tradename, Tosoh Corporation) as the gel permeation chromatographing device, using 4 columns in total, i.e., one “TSKgel G4000H×L”, two “TSKgel G3000H×L” and one “TSKgel G2000H×L” (tradenames, Tosoh Corporation) and a differential refratometer as the detector, under the conditions of mobile phase: tetrahydrofuran, measuring temperature: 40° C., and flow rate: 1 mL/min.

Examples of the carboxyl-containing polymerizable unsaturated monomer include unsaturated monocarboxylic acids such as (meth)acrylic acid and crotonic acid; and unsaturated dicarboxylic acids such as maleic acid, fumaric acid and itaconic acid or half-monoalkyl-esterification products of these dicarboxylic acids. Examples of hydrophilic group-containing polymerizable unsaturated monomers other than the above include polyoxyalkylene chain-containing polymerizable unsaturated monomers such as polyethylene glycol(meth)acrylate, polypropylene glycol(meth)acrylate and methoxypolyethylen glycol(meth)acrylate; sulfonic acid group-containing polymerizable unsaturated monomers such as 2-acrylamide-2-methlpropanesulfonic acid and sulfoalkyl(meth)acrylates such as 2-sulfoethyl(meth)acrylate; tertiary amino group-containing polymerizable unsaturated monomers such as N,N-dimethylaminoethyl(meth)acrylate and N,N-diethylaminoethyl(meth)acrylate; quaternary ammonium salt group-containing polymerizable unsaturated monomers such as 2-(methacryloyloxy)ethyltrimethylammonium chloride and 2-(methacryloyloxy)ethyltrimethylammonium bromide; and quaternary ammonium salt-formed carboxyl group-containing polymerizable unsaturated monomers.

Examples of the other polymerizable unsaturated monomers include C₁₋₂₄ alkyl or cycloalkyl esters of (meth)acrylic acid such as methyl(meth)acrylate, ethyl(meth)acrylate, n- or i-propyl(meth)acrylate, n-, i- or t-butyl(meth)acrylate, 2-ethylhexyl(meth)acrylate, cyclohexyl(meth)acrylate, lauryl(meth)acrylate and isobornyl(meth)acrylate; hydroxyalkyl esters of (meth)acrylic acid such as 2-hydroxyethyl(meth)acrylate, 2- or 3-hydroxypropyl(meth)acrylate and 4-hydroxybutyl(meth)acrylate; glycidyl(meth)acrylate, acrylonitrile, acrylamide, styrene, vinyltoluene, vinyl acetate, vinyl chloride and 1,6-hexanediol acrylate. These monomers can be used either alone or in combination of two or more.

Copolymerization of said monomer mixtures is subject to no particular limitation, but can be carried out by any of the methods known per se. For example, water-soluble acrylic resins can be formed by solution polymerization method, and acrylic resin emulsions, by emulsion polymerization method.

In particular, when the aqueous acrylic resin (B-2) is an acrylic resin emulsion obtained by emulsion polymerization, it may be a multilayer-structured, particulate emulsion obtainable through multi-stage emulsion polymerization of the monomer mixture in the presence of water and an emulsifier.

Where necessary, those acidic groups such as carboxyl attributable to the hydrophilic group-containing polymerizable unsaturated monomer(s) in the aqueous acrylic resin (B-2) can be neutralized with basic substance. The basic substance is preferably water-soluble, examples of which include ammonia, methylamine, ethylamine, propylamine, butylamine, dimethylamine, trimethylamine, triethylamine, ethylenediamine, morpholine, methylethanolamine, dimethylethanolamine, diethanolamine, triethanolamine, di-isopropanolamine and 2-amino-2-methylpropanol. These basic substances can be used either alone or in combination of two or more.

It is desirable for the aqueous acrylic resin (B-2) to contain, at least as a part of its components, a polyoxyalkylene chain-containing water-soluble acrylic resin, for improving dispersibility of later described electrically conducting pigment (D).

It is desirable for the aqueous acrylic resin (B-2) to contain hydroxyl groups, and in respect of its dispersibility in water, compatibility with other components, and curability of the coating film formed, to have a hydroxyl value within a range of generally 20-200 mgKOH/g, in particular, 20-175 mgKOH/g, inter alia, 20-150 mgKOH/g; and an acid value within a range of generally 1-100 mgKOH/g, in particular, 5-85 mgKOH/g, inter alia, 10-70 mgKOH/g.

Above-described aqueous dispersion (A) and aqueous urethane resin and/or aqueous acrylic resin (B) can be used, in terms of the solid mass ratio of the component (A)/component (B), within a range of generally 10/90-70/30, preferably 15/85-70/30, inter alia, 20/80-65/35. Deviation from the above-specified ratio is undesirable because it may cause reduction in adhesiveness to the substrate, water resistance and gasohol resistance of the formed coating film.

### Pyrazole-Blocked Polyisocyanate Compound (C):

The blocked polyisocyanate compound (C) to be used in the water-based primer composition of the invention is obtained by blocking isocyanate groups in a polyisocyanate compound having at least two free isocyanate groups, with pyrazole or a pyrazole derivative.

Examples of the polyisocyanate compound include aliphatic polyisocyanates such as hexamethylene diisocyanate, trimethylhexamethylene diisocyanate, dimeric acid diisocyanate and lysine diisocyanate; biuret type adducts or isocyanurate ring adducts of these aliphatic polyisocyanates; alicyclic diisocyanates such as isophorone diisocyanate, 4,4′-methylenebis(cyclohexylisocyanate), methylcyclohexane-2,4- or 2,6-diisocyanate, 1,3- or 1,4-di(isocyanatomethyl)cyclohexane, 1,4-cyclohexane diisocyanate, 1,3-cyclopentane diisocyanate, and 1,2-cyclohexane diisocyanate; biuret type adducts or isocyanurate ring adducts of these alicyclic polyisocyanates; aromatic diisocyanate compounds such as xylylene diisocyanate, tetramethylxylylene diisocyanate, tolylene diisocyanate, 4,4′-diphenylmethane diisocyanate (MDI), 1,5-naphthalene diisocyanate, 1,4-naphthalene diisocyanate, 4,4′-toluidine diisocyanate, 4,4′-diphenylether diisocyanate, (m- or p-)phenylene diisocyanate, 4,4′-biphenylene diisocyanate, 3,3′-dimethyl-4,4′-biphenylene diisocyanate, bis(4-isocyanatophenyl)sulfone, and isopropylidenebis-(4-phenylisocyanate); biuret type adducts or isocyanurate ring adducts of these aromatic polyisocyanates; hydrogenated MDI and hydrogenated MDI derivatives; polyisocyanates having at least three isocyanate groups per molecule such as triphenylmethane-4,4′,4″-triisocyanate, 1,3,5-triisocyanatobenzene, 2,4,6-triisocyanatotoluene, and 4,4′-dimethyldiphenylmethane-2,2′,5,5′-tetraisocyanate; biuret type adducts or isocyanurate ring adducts of these polyisocyanate; urethanated adducts formed by reaction of such polyisocyanate compounds with polyols such as ethylene glycol, propylene glycol, 1,4-butylene glycol, dimethylolpropionic acid, polyalkylene glycol, trimethylolpropane and hexanetriol, at such a ratio that the isocyanate groups become in excess of the hydroxyl groups in the polyol used; and biuret type adducts or isocyanurate ring adducts of these urethanated adducts.

Examples of the pyrazole or pyrazole derivatives include pyrazole, 3,5-dimethylpyrazole, 3-methylpyrazole, 4-benzyl-3,5-dimethylpyrazole, 4-nitro-3,5-dimethylpyrazole, 4-bromo-3,5-dimethylpyrazole, and 3-methyl-5-phenylpyrazole. Of these, 3,5-dimethylpyrazole is favorably used, in respect of improving water resistance in particular.

The pyrazole-blocked polyisocyanate compound (C) preferably has a number-average molecular weight generally no more than 3000, in particular, within a range of 300-2000, inter alia, 500-1500, from the viewpoint of improving dispersibility in water or finished effect of resulting multilayer coating film. In the present specification, the number-average molecular weight of the pyrazole-blocked polyisocyanate compound is the value calculated from its chromatogram measured by gel permeation chromatography, based on the molecular weight of standard polystyrene.

The pyrazole-blocked polyisocyanate compound (C) content in the water-based primer composition of the invention is within a range of generally 5-50 mass %, preferably 7.5-45 mass %, inter alia, 10-40 mass %, based on the total solid content of the components (A), (B) and (C). When it deviates from the above range downwards, the coating film may have insufficient water resistance. Upward deviation, on the other hand, is undesirable because it is liable to adversely affect the finished effect of formed coating film or storage stability of the paint.

### Electrically Conducting Pigment (D):

The electrically conducting pigment (D) to be used in the water-based primer composition of the invention is subject to no particular limitation, so long as it is capable of imparting electric conductivity to the coating film formed. It can be used in any per se known forms such as particles, flakes or fibers (including whiskers). In particular, the electrically conductive pigment (D) preferably contains an electrically conductive metal oxide (D-1) according to the invention. As the electrically conductive metal oxide (D-1), those in various forms such as particles, needles, or plates can be used, particulate electrically conductive metal oxide being particularly preferred in respect of storage stability of the composition and finished effect of the coating film formed. With the view to improve the conductivity, platy electrically conducting metal oxide may be used concurrently with particulate electrically conducting metal oxide. In case of such concurrent use, the mass ratio of the particulate electrically conducting metal oxide/platy electrically conducting metal oxide is preferably within a range of generally 99/1-50/50, in particular, 95/5-50/50, inter alia, 90/10-50/50.

In respect of storage stability of the composition or finished effect of the coating film, the particulate electrically conducting metal oxide conveniently has an average particle size within a range of normally 0.05-1 μm, in particular, 0.07-0.75 μm, inter alia 0.1-0.5 μm. Here the average particle size can be measured with a laser diffraction scattering-type analyzer device (tradename: “Microtrac FRA”, Nikkiso Co.).

Examples of the particulate electrically conducting metal oxide include those containing tin oxide as the chief component, or those made of a substrate of, e.g., titanium oxide, silica, zinc oxide or barium sulfate, having on the surface thereof an electrically conducting layer containing tin oxide, nickel oxide, phosphorus, antimony and the like. Specific examples on the market include “ET500W”, “ET521W”, “ET600W” and “ET300W” (tradenames, Ishihara Sangyo Kaisha; “EC100” and “EC210 (tradenames, Titan Kogyo). Of these, particularly electrically conducting titanium oxide having on its surface a conductive layer containing tin oxide and antimony is preferred. Such an electrically conducting titanium oxide having on its surface a conductive layer containing tin oxide and antimony preferably contains tin oxide in terms of metal element ratio to titanium oxide, Sn/Ti, of 45/55-5/95 (mass ratio), and antimony, 1-5 mass % to the pigment, in respect of electric conductivity and value.

Platy electrically conducting metal oxide preferably has an average longer axis length within a range of generally 1-30 μm, in particular, 2-25 μm; and an average thickness within a range of generally 0.01-1 μm, in particular, 0.02-1 μm, in respect of the finished effect and electric conductivity. Here the average longer axis length can be measured with a laser diffraction scattering-type analyzer device (tradename: Microtrac FRA, Nikkiso Co.), and the average thickness is calculated on direct electron microscopic observation.

As examples of such platy electrically conducting metal oxide, those made of a substrate, e.g., platy titanium oxide or mica, having on the surface thereof an electrically conducting layer containing tin oxide or nickel oxide, phosphorus, antimony and the like can be named. Specific examples on the market include “Dentole TM200” (tradename, Otsuka Chemical Co.), “Minatec 40CM” and “Minatec 30CM” (tradenames, Merck KGaA). Of these, electrically conducting titanium oxide and/or electrically conducting mica having on their surfaces an electrically conducting layer containing tin oxide are particularly preferred. Those electrically conducting titanium oxide or electrically conducting mica with an electrically conducting surface layer containing titanium oxide preferably contain tin oxide at a ratio to the titanium oxide or mica of normally 10/90-50/50 (mass ratio), in respect of good balance between the conductivity and value.

The water-based primer composition of the invention can contain such an electrically conducting pigment (D) within a range of generally 50-200 mass parts, preferably 60-185 mass parts, inter alia, 70-170 mass parts, per 100 mass parts of the total solid resin content. Deviation of the pigment (D) content from the above range is undesirable because it is liable to result in insufficient electric conductivity or reduction in adhesiveness or water resistance of the coating film formed.

The water-based primer composition of the invention may further contain pigment(s) other than the above electrically conducting pigment, for example, a coloring pigment such as titanium oxide, red iron oxide, aluminum paste, azo or phthalocyanine pigments; and an extender such as talc, silica, calcium carbonate, barium sulfate, and zinc flower (zinc oxide). Those can be used either alone or in combination of two or more.

The water-based primer composition of the invention can be formulated by, for example, mixing the so far described (A) aqueous dispersion of modified polyolefin, (B) aqueous urethane resin and/or aqueous acrylic resin, (C) pyrazole-blocked polyisocyanate compound and (D) electrically conducting pigment, according to the accepted practice, and diluting the same suitably with an aqueous medium such as deionized water.

### Diester Compound (E)

The water-based primer composition of the invention may further contain, where necessary, a diester compound (E) of a general formula:

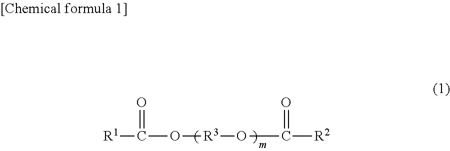

[in the formula, R¹ and R² stand for C₄₋₁₈ hydrocarbon groups independently of each other, R³ stands for a C₂₋₄ alkylene group, and m is an integer of 3-20, said m R³s being same or different]
for improving water resistance and finished effect of the coating film formed. Blending of the diester compound (E) allows the composition to exhibit excellent film-forming property and secures its electric conductivity. It furthermore prevents layer mixing between the formed coating film and the upper layer coating film to enable formation of multilayer coating film which exhibits excellent finished effect and water resistance.

As the hydrocarbon groups represented by R¹ or R² in the formula (1), C₅₋₁₁ alkyl, in particular, C₅₋₉ alkyl, inter alia, C₆₋₆ alkyl groups, are preferred. Particularly when R¹ and R² are C₆₋₆ branched alkyl, the primer composition exhibits excellent film-forming property even after relatively long term storage. R³ is preferably ethylene, and m is preferably an integer of 3-15, in particular, 4-10.

The diester compound (E) can be obtained, for example, through a diesterification reaction of a polyoxyalkylene glycol having two end hydroxyl groups with a monocarboxylic acid having C₄₋₁₈ hydrocarbon group.

Examples of the polyoxyalkylene glycol include polyethylene glycol, polypropylene glycol, block copolymers of polyethylene glycol and polypropylene glycol and polybutylene glycol. Of these, use of polyethylene glycol is particularly preferred. In respect of water resistance, these polyoxyalkylene glycols preferably have weight-average molecular weight within a range of generally from about 120 to about 800, in particular, from about 150 to about 600, inter alia, from about 200 to about 400.

Examples of the monocarboxylic acid having C₄₋₁₈ hydrocarbon group include pentanoic acid, hexanoic acid, 2-ethylbutanoic acid, 3-methylpentanoic acid, benzoic acid, cyclohexanecarboxylic acid, heptanoic acid, 2-ethylpentanoic acid, 3-ethylpentanoic acid, octanoic acid, 2-ethylhexanoic acid, 4-ethylhexanoic acid, nonanoic acid, 2-ethylheptanoic acid, decanoic acid, 2-ethyloctanoic acid, 4-ethyloctanoic acid, dodecanoic acid, hexadecanoic acid and octadecanoic acid. Of these, the preferred are monocarboxylic acids having C₅₋₉ alkyl, such as hexanoic acid, heptanoic acid, 2-ethylpentanoic acid, 3-ethylpentanoic acid, octanoic acid, 2-ethylhexanoic acid, 4-ethylhexanoic acid, nonanoic acid, 2-ethylheptanoic acid, decanoic acid, 2-ethyloctanoic acid and 4-ethyloctanoic acid; in particular, monocarboxylic acids having C₆₋₈ alkyl, such as heptanoic acid, 2-ethylpentanoic acid, 3-ethylpentanoic acid, octanoic acid, 2-ethylhexanoic acid, 4-ethylhexanoic acid, nonanoic acid and 2-ethylheptanoic acid; inter alia, monocarboxylic acids having C₆₋₈ branched alkyl, such as 2-ethylpentanoic acid, 3-ethylpentanoic acid, 2-ethylhexanoic acid, 4-ethylnexanoic acid and 2-ethylheptanoic acid.

The diesterification reaction of the polyoxylakylene glycol with the monocarboxylic acid can be performed by the method known per se. Those polyoxyalkylene glycols and the monocarboxylic acids may be used each alone or in combination of two or more.

Thus obtained diester compound (E) preferably has a molecular weight within a range of generally from about 320 to about 1,000; in particular, from about 400 to about 800; inter alia, from about 500 to about 700; in respect of film-forming property, finished effect and water resistance.

The diester compound (E) content in the water-based primer composition of the invention is within a range of generally 1-15 mass parts, preferably 2-13.5 mass parts, inter alia, 3-12 mass parts, per 100 mass parts of the total solid content of the components (A), (B) and (C), in consideration of water resistance and finished effect of the coating film formed.

### Other Additives:

The water-based primer composition of the invention may further contain, where necessary, aqueous resin(s) other than the components (A) and (B), curing agent other than the component (C), and furthermore optionally such paint additives as curing catalyst, thickener, defoamer, dispersant, organic solvent and surface-regulating agent.

### Coating Methods:

The water-based primer composition of the invention is applicable onto plastic substrate surface. As the plastic substrate, for example, outer panels of automobiles such as bumpers, spoilers, grilles and fenders; and outer panels of household electric appliances can be named. As the plastic material, polyolefins obtained through (co)polymerization of one or more of C₂₋₁₀ olefins such as ethylene, propylene, butylene, hexene and the like are particularly preferred. Other than those, the water-based primer composition of the invention is also applicable to polycarbonate, ABS resin, urethane resin, polyamide and the like.

These plastic substrate surfaces may be given such a treatment as degreasing, washing with water or the like by the means known per se, in advance of the coating with a water-based primer composition of the invention.

Coating with the water-based primer composition can be carried out by such means as air spraying, airless spraying, dipping or brushing, onto the plastic substrate surface to provide its coating film of a thickness, in terms of dry film, within a range of normally 1-40 μm, preferably 5-35 μm. After being coated with the composition, the coated surface may be set at room temperature for around 30 seconds-60 minutes, or pre-heated at about 40-about 80° C. for around 1-60 minutes, where necessary; or it may be cured by heating at about 60-about 140° C., preferably at about 70-about 120° C., for around 20-40 minutes.

Thus formed primer coating film has electric conductivity. It is generally desirable that the surface resistivity of the cured coating film is not higher than 1×10⁸Ω/□, in particular, not higher than 1×10⁷Ω/□, whereby the electrically conducting primer coating film enables favorable electrostatic coating in the next step. Here the “surface resistivity” can be measured with “TREK MODEL 150” (tradename, TREK Inc.) surface resistivity meter, as to each sample coating film of about 15 μm in dry thickness, which has been dried at 80° C. for 10 minutes (unit: Ω/□).

Onto the uncured or cured primer coating film formed of the water-based primer composition of the invention, then a top coat can be applied by electrostatic coating method. As the top coat, a coloring paint may be used by itself, or the coloring paint may be used as a base coat, followed by subsequent application of a clear paint. As such coloring base paint, those known per se can be used, which generally contain a coloring component such as coloring pigment, effect pigment, dye and the like, and resin components such as a base resin, crosslinking agent and the like, with organic solvent and/or water serving as the chief solvent.

According to the invention, water-based non-conductive coloring base paint can be conveniently used as the coloring base paint. Furthermore, it is also possible to sequentially apply water-based non-conductive white base paint and water-based iridescent color base paint to form a multilayer coating film.

As the water-based non-conductive coloring base paint, those known per se can be used, which normally contain a coloring component such as coloring pigment, effect pigment, dye, and the like, and resin components such as a base resin, crosslinking agent and the like, with water serving as the chief solvent.

As the base resin to be used in above water-based non-conductive coloring base paint or water-based iridescent coloring base paint, for example, acrylic resin, polyester resin and the like which have reactive functional groups such as hydroxyl or carboxyl can be used, hydroxyl-containing acrylic resin being particularly preferred. Also as the crosslinking agent used in the water-based non-conductive coloring base paint or water-based iridescent coloring base paint, for example, amino resin such as melamine resin and urea resin; (blocked) polyisocyanate; carbodiimide; and the like can be used, which have reactive functional groups reactable with above-named functional groups. The pyrazole-blocked polyisocyanate compound as described in the earlier explanation of the water-based primer composition may also be suitably used.

Those water-based non-conductive coloring base paint or water-based iridescent coloring base paint can further contain, where necessary, paint additives such as extender, curing catalyst, UV absorber, surface regulating agent, dispersant, rheology controlling agent, antioxidant, defoamer, wax, antiseptic and the like.

Such coloring base paint can be applied onto the uncured or cured primer coating film, to the dry coating film thickness within a range of normally 5-50 preferably 5-30 μm, inter alia, 7-20 μm, by electrostatic coating method. The resulting coated surface may be, where necessary, set at room temperature for around 1-60 minutes, or pre-heated at about 40-about 80° C., for around 1-60 minutes; or it may be cured at about 60-about 140° C., preferably at about 80-about 120° C., for around 20-40 minutes. Where a water-based non-conductive white base paint and a water-based iridescent coloring base paint are sequentially applied to form a coloring base coating film, each similar coating conditions can be adopted.

According to the invention, it is particularly preferred to subsequently apply a clear paint, without curing the coloring base paint after its application as above.

The clear paint is, for example, an organic solvent-based or water-based thermosetting paint comprising resin components such as a base resin, crosslinking agent and the like, organic solvent or water; and furthermore, where necessary, containing as blended therewith such paint additives as UV absorber, photostabilizer, curing catalyst, surface regulating agent, rheology controlling agent, antioxidant, defoamer, wax and the like, which has the transparency such that the coating film formed thereof allows perception of the underlayer therethrough.

Examples of the base resin include such acrylic resin, polyester resin, alkyd resin, fluorine-containing resin, urethane resin and silicone-containing resin which contain at least one kind of reactive functional group selected from, for example, hydroxyl, carboxyl, silanol and epoxy groups. Hydroxyl-containing acrylic resin is particularly suitable. Examples of the crosslinking agent include melamine resin, urea resin, (blocked) polyisocyanate compound, epoxy compound, carboxyl-containing compound, acid anhydride and alkoxysilane group-containing compound, which have reactive functional groups reactable with above-named functional groups. Polyisocyanate compound is particularly suitable.

Coating of the clear paint can be performed by applying it onto the uncured or cured coloring base coating film, by electrostatic coating method, to its dry coating film thickness within a range of normally 10-50 μm, preferably 20-40 μm. The resulting coated surface may be, where necessary, set at room temperature for around 1-60 minutes, or pre-heated at about 40-about 80° C. for around 1-60 minutes, and thereafter cured by heating at about 60-about 140° C., preferably about 70-about 120° C., for around 20-40 minutes.

### EXAMPLES

Hereinafter the invention is explained more specifically, referring to Examples, it being understood that the invention is not limited to these Examples only. In the Examples, “parts” and “%” mean “mass parts” and “mass %” unless indicated otherwise.

### Preparation of Water-Based Primers

### Example 1

Water-based primer (1) was obtained by mixing 30 parts of an aqueous dispersion (A-1) of a modified polyolefin (note 1) in terms of solid mass, 25 parts of an aqueous acrylic resin (B-1) (note 4) as solid mass, 25 parts of an aqueous acrylic resin (B-2) (note 5) as solid mass, 20 parts of a blocked polyisocyanate compound (C-1) (note 7) as solid mass, and 150 parts of an electrically conducting pigment (D-1) (note 9), by a conventional means; and diluting the resulting mixture with deionized water to render its solid content 40%.

### Examples 2-13 and Comparative Examples 1-6

Example 1 was repeated except that the composition of the blends were changed as indicated in the following Table 1, to provide water-based primers (2)-(19). Storage stability of each of so obtained water-based primers was evaluated, with the results as concurrently shown in Table 1.

The composition of the blends in Table 1 is shown by the respective solid contents, (note 1)-(note 15) identifying the components being as follows:

(Note 1) Aqueous dispersion (A-1) of modified polyolefin: an ethylene-propylene copolymer (ethylene content 5%), which had been obtained with use of metallocene catalyst, was modified by addition of 8 mass % of maleic acid, providing a modified polyolefin having a melting point of 80° C., Mw of about 100,000 and Mw/Mₙ of about 2.1. The modified polyolefin was neutralized with equivalent amount of dimethylethanolamine, and dispersed in water using 10 parts of an emulsifier per 100 parts of the propylene/ethylene copolymer.
(Note 2) Aqueous dispersion (A-2) of modified polyolefin: “HARDLEN NA-3002”, tradename, an aqueous dispersion of non-chlorinated polyolefin, Toyo Kasei Kogyo Co.; solid content 30%.
(Note 3) Aqueous dispersion (A-3) of modified polyolefin: “EH-801”, tradename, an aqueous dispersion of chlorinated polyolefin, Toyo Kasei Kogyo Co.; degree of chlorination 16% and solid content 30%.
(Note 4) Aqueous acrylic resin (B-1); “BAYHYDROL XP2427”, tradename, a hydroxyl-containing acrylic resin emulsion, Sumika Bayer Urethane Co.
(Note 5) Aqueous acrylic resin (B-2): A reactor equipped with a thermometer, thermostat, stirrer, reflux condenser and dropping device was charged with 35 parts of propylene glycol monomethyl ether and 25 parts of propylene glycol monobutyl ether, and heated under stirring and kept at 110° C. Into the reactor then a mixture of “NF BISOMER S20W” (tradename, Dai-ichi Kogyo Seiyaku Co., methoxypolyethylene glycol monomethacrylate) 15 parts, 2-hydroxyethyl acrylate 10 parts, methyl methacrylate 30 parts, n-butyl acrylate 15 parts, styrene 5 parts, isobornyl acrylate 20 parts, acrylic acid 5 parts, azobisisobutyronitrile 1 part, and propylene glycol monomethyl ether 20 parts was dropped over 3 hours. After the dropping ended, the reaction product was aged at 110° C. for 30 minutes, followed by further dropping of additional liquid catalyst mixture composed of 15 parts of propylene glycol monomethyl ether and 0.5 part of azobisisobutyronitrile over an hour. The reaction product was aged at 110° C. for an hour and cooled to provide an aqueous acrylic resin solution (B-2) having a solid content of 50%.
(Note 6) Aqueous urethane resin (B-3): “U-COAT UX-310”, tradename, Sanyo Chemical Industries, an aqueous urethane dispersion.
(Note 7) Blocked polyisocyanate compound (C-1): A 4-necked flask equipped with a stirrer, heater, cooler and decompressor was charged with 250 parts of “SUMIDUR N3300”, (tradename, Sumika Bayer Urethane Co., an isocyanurate compound of hexamethylene diisocyanate) and 125 parts of methyl ethyl ketone, and heated to 30° C., followed by addition of 126 parts of 3,5-dimethylpyrazole gradually under stirring, over 2 hours. The reaction mixture was then reacted at 30° C. under stirring, until free isocyanate group became no more detectable by infrared spectrophotometry. At the end of the reaction, a solution of pyrazole-blocked polyisocyanate compound (C-1) having a solid content of 70% was obtained. Thus obtained blocked polyisocyanate compound (C-1) had an NCO content of 14.4% and a number-average molecular weight of 1000. In this specification, NCO content means the quantity of NCO group (%) to 100 mass parts of the solid resin content.
(Note 8) Blocked polyisocyante compound (C-2): A 4-necked flask equipped with a stirrer, heater, cooler and decompressor was charged with 272 parts of hexamethylene diisocyanate and 214 parts of methyl ethyl ketone, and heated to 60° C. Then 169 parts of methyl ethyl ketoxime was gradually added under stirring for an hour, followed by 2 hours' reaction at 60° C. To the system then 59 parts of trimethylolpropane was gradually added not to raise the temperature of the system higher than 70° C., followed by further reaction at 60° C. under stirring, until no free isocyanate group became detectable by infrared spectrophotometry. At the end of the reaction, a solution of a blocked polyisocyanate compound (C-2) having a solid content of 70% was obtained. Thus obtained blocked polyisocyanate compound (C-2) had an NCO content of 16.4% and a number-average molecular weight of 950.
(Note 9) Electrically conducting pigment (D-1): “ET-500W” tradename, Ishihara Sangyo Kaisha, particulate electrically conducting titanium oxide with antimony-doped tin oxide layer at the surface
(Note 10) Electrically conducting pigment (D-2): “EC-100”, tradename, Titan Kogyo, Ltd., particulate electrically conducting titanium oxide with antimony-doped tin oxide layer at the surface.
(Note 11) Electrically conducting pigment (D-3): “MINATEC 40CM”, tradename, Merck KGaA, electrically conducting mica.
(Note 12) Electrically conducting pigment (D-4): “VULCAN XC72”, tradename, Cabot Specialty Chemicals Inc., electrically conducting carbon black.
(Note 13) Titanium white: “JR-903”, tradename, TAYCA Corporation.
(Note 14) Diester compound (E-1): a diester compound of polyoxyethylene glycol with n-hexanoic acid, which is a compound of the general formula (1) wherein both R¹ and R² are pentyl, R³ is ethylene and m is 5; molecular weight: 434.
(Note 15) Diester compound (E-2): a diester compound of polyoxyethylene glycol with 2-ethylhexanoic acid, which is a compound of the general formula (1) wherein both R¹ and R² are 2-ethylpentyl, R³ is ethylene and m is 7; molecular weight: 578.

Storage stability: Each of the water-based primers (1)-(19) was stored at 40° C. for 10 days, and its condition in the container was visually observed and evaluated according to the following standard:
◯: the initial condition maintained without any change
Δ: viscosity rose slightly
x: pigment sedimentation or nibbs occurred, or viscosity rose drastically.

TABLE 1

| | | Example | | | | | | | | | |
|---|---|---|---|---|---|---|---|---|---|---|---|
| | | 1 | 2 | 3 | 4 | 5 | 6 | 7 | 8 | 9 | 10 |
| Water-based primer | | (1) | (2) | (3) | (4) | (5) | (6) | (7) | (8) | (9) | (10) |
| Aqueous | A-1 (note 1) | 30 | | | 50 | 50 | 30 | 50 | 50 | 30 | |
| dispersion of | A-2 (note 2) | | 30 | | | | | | | | |
| modified polyolefin | A-3 (note 3) | | | 30 | | | | | | | 30 |
| Aqueous acrylic resin (B-1) (note 4) | | 25 | 25 | 25 | 15 | 10 | 25 | 10 | 10 | 25 | 25 |
| Aqueous acrylic resin (B-2) (note 5) | | 25 | 25 | 25 | 20 | 10 | 25 | 20 | 30 | 25 | 25 |
| Aqueous urethane resin (B-3) | | | | | | 10 | | | | | |
| (note 6) | | | | | | | | | | | |
| Blocked | C-1 (note 7) | 20 | 20 | 20 | 15 | 20 | 20 | 20 | 10 | 20 | 20 |
| polyisocyanate | C-2 (note 8) | | | | | | | | | | |
| comound | | | | | | | | | | | |
| Electrically | D-1 (note 9) | 150 | 150 | 150 | 150 | 150 | 130 | 150 | 150 | 100 | 100 |
| conducting | D-2 (note 10) | | | | | | | | | | |
| pigment | D-3 (note 11) | | | | | | | | | | |
| | D-4 (note 12) | | | | | | | | | | |
| Titanium white (note 13) | | | | | | | | | | 50 | 50 |
| Diester compound | E-1 (note 14) | | | | | 10 | 10 | | | 10 | 10 |
| | E-2 (note 15) | | | | | | | 10 | 5 | | |

| | | | | | | | | | | |
|---|---|---|---|---|---|---|---|---|---|---|
| Solid paint content (%) | 40 | 40 | 40 | 40 | 40 | 40 | 40 | 40 | 40 | 40 |
| Storage stability | ◯ | ◯ | ◯ | ◯ | ◯ | ◯ | ◯ | ◯ | ◯ | ◯ |
| Whiteness | ◯ | ◯ | ◯ | ◯ | ◯ | ◯ | ◯ | ◯ | ⊙ | ⊙ |
| Electric conductivity | ◯ | ◯ | ◯ | ◯ | ◯ | ◯ | ◯ | ◯ | ◯ | ◯ |

| | | Example | | | Comparative Example | | | | | |
|---|---|---|---|---|---|---|---|---|---|---|
| | | 11 | 12 | 13 | 1 | 2 | 3 | 4 | 5 | 6 |
| Water-based primer | | (11) | (12) | (13) | (14) | (15) | (16) | (17) | (18) | (19) |
| Aqueous | A-1 (note 1) | 30 | 30 | 30 | 30 | 30 | 30 | 30 | 15 | 30 |
| dispersion of | A-2 (note 2) | | | | | | | | | |
| modified polyolefin | A-3 (note 3) | | | | | | | | | |
| Aqueous acrylic resin (B-1) (note 4) | | 25 | 15 | 15 | 30 | 30 | 30 | 30 | | 25 |
| Aqueous acrylic resin (B-2) (note 5) | | 25 | 15 | 15 | 20 | 20 | 20 | 20 | 15 | 25 |
| Aqueous urethane resin (B-3) | | | | | | | 20 | 20 | | |
| (note 6) | | | | | | | | | | |
| Blocked | C-1 (note 7) | 20 | 40 | 40 | 20 | 20 | | | 70 | |
| polyisocyanate | C-2 (note 8) | | | | | | | | | 20 |
| comound | | | | | | | | | | |
| Electrically | D-1 (note 9) | 150 | | | 300 | 40 | 150 | | 150 | 150 |
| conducting | D-2 (note 10) | | 150 | 150 | | | | | | |
| pigment | D-3 (note 11) | 5 | | 5 | | | | | | |
| | D-4 (note 12) | | | | | | | 5 | | |

| | | |
|---|---|---|
| Titanium white (note 13) | 110 | 150 |

| | | | | | |
|---|---|---|---|---|---|
| Diester compound | E-1 (note 14) | 10 | 5 | 5 | 10 |
| | E-2 (note 15) | | | | |

| | | | | | | | | | |
|---|---|---|---|---|---|---|---|---|---|
| Solid paint content (%) | 40 | 40 | 40 | 40 | 40 | 40 | 40 | 40 | 40 |
| Storage stability | ◯ | ◯ | ◯ | Δ | ◯ | ◯ | ◯ | X | ◯ |
| Whiteness | ◯ | ◯ | ◯ | X | ⊙ | ◯ | X | ◯ | ◯ |
| Electric conductivity | ⊙ | ◯ | ⊙ | ⊙ | X | ◯ | ◯ | ◯ | ◯ |

### Preparation of Coated Test Samples (1)

Shaped black-colored polypropylene bumpers (degreased) were air spray-coated with each of water-based primers (1)-(19) as prepared in the above, to the dry film thickness of about 15 μm. Those coated films were left at room temperature for 2 minutes, and heat-cured at 80° C. for 10 minutes. The coatings' whiteness (L* value) and electric conductivity (surface resistivity) were evaluated, with the results as shown concurrently in Table 1.

Whiteness (L* value): Value L* value of each coated film was measured with “CR-300” (tradename, Minolta Co.) and evaluated according to the following standard:
[symbol] : L* value was 85 or higher
◯: L* value was at least 80 but less than 85
Δ: L* value was at least 70 but less than 80
x: L* value was less than 70.

Electric conductivity (surface resistivity): Surface resistivity (Ω/□) of each coated film was measured with “MODEL 150” (tradename, TREC Inc.) at 20° C., and evaluated according to the following standard:
[symbol] : Less than 1MΩ
◯: At least 1MΩ but less than 10MΩ
Δ: At least 10MΩ but less than, 1,000MΩ
x: 1,000MΩ or higher.

### Preparation of Coated Test Samples (2)

Shaped black-colored polypropylene bumpers (degreased) were spray-coated with each of water-based primers (1)-(19) as prepared in the above, to the dry film thickness of about 15 μm. After 5 minutes' pre-heating at 55° C., “WBC710 Pale Color Metallic Base” tradename, Kansai Paint Co., a water-based pale metallic color base coating paint) was applied as a coloring base coat, by electrostatic coating on the primer coating film to a dry film thickness of about 15 μm, pre-heated at 80° C. for 5 minutes, and “SFX 7172 CLEAR” (tradename, Kansai Paint Co., an acrylic urethane solvent-based clear paint) was coated thereon by electrostatic coating to a dry film thickness of about 30 μm, set for 10 minutes, and heat-dried at 120° C. for 30 minutes to provide the coated test samples.

### Preparation of Coated Test Samples (3)

Shaped black-colored polypropylene bumpers (degreased) were spray-coated with each of water-based primers (1)-(19) as prepared in the above, to the dry film thickness of about 15 μm. After 5 minutes' pre-heating at 55° C., “WBC 710 White Base” (tradename, Kansai Paint Co., a water-based white base coating paint) was applied as a coloring base coat by electrostatic coating on the primer coating film, to a dry film thickness of about 15 followed by electrostatic coating thereon of “WBC 710 Mica Base” (tradename, Kansai Paint Co., water-based iridescent color base coating paint) to a dry film thickness of about 8 μm, and pre-heating at 80° C. for 5 minutes. Subsequently, “SFX 7172 CLEAR” (tradename, Kansai Paint Co., an acrylic urethane solvent-based clear paint) was applied on the coated surface by electrostatic coating method to a dry film thickness of about 25 μm, followed by 10 minutes' setting and then 30 minutes' heat-drying at 120° C. to provide the coated test samples.

Each of the coated test samples (2) and (3) were given the following performance tests. The results were as shown in Table 2.

### Performance Test Methods

Water resistance: A part of each of the coated articles was cut out, dipped in warm water of 40° C. for 10 days, withdrawn and dried. The surface of each sample was cross-cut with a cutter to the depth reaching the plastic substrate to mark one-hundred 2 mm×2 mm squares. An Adhesive Cellophane Tape (registered trademark) was stuck on the surface and rapidly peeled off at 20° C. The remaining number of squares of the coating film was counted and evaluated according to the following standard:
◯: One-hundred squares (no peeling)
Δ: 70-99 squares
x: 69 or less squares.

Finished effect: Each multilayer coating film was visually observed and evaluated according to the following standard:
[symbol] : excellent gloss and smoothness
◯: gloss and smoothness less favorable but no practical problem
Δ: inferior gloss and smoothness
x: markedly inferior gloss and smoothness.

TABLE 2

| | | Example | | | | | | | | | | | | | Comparative Example | | | | | |
|---|---|---|---|---|---|---|---|---|---|---|---|---|---|---|---|---|---|---|---|---|
| | | 1 | 2 | 3 | 4 | 5 | 6 | 7 | 8 | 9 | 10 | 11 | 12 | 13 | 1 | 2 | 3 | 4 | 5 | 6 |
| Water-based primer | | (1) | (2) | (3) | (4) | (5) | (6) | (7) | (8) | (9) | (10) | (11) | (12) | (13) | (14) | (15) | (16) | (17) | (18) | (19) |
| Performance test | Water- | ◯ | ◯ | ◯ | ◯ | ◯ | ◯ | ◯ | ◯ | ◯ | ◯ | ◯ | ◯ | ◯ | X | ◯ | X | X | ◯ | X |
| result of coated | resistance | | | | | | | | | | | | | | | | | | | |
| test samples (2) | Finished effect | ◯ | ◯ | ◯ | ◯ | ⊙ | ⊙ | ⊙ | ⊙ | ⊙ | ⊙ | ⊙ | ⊙ | ⊙ | X | ◯ | ◯ | ◯ | X | ◯ |
| Performance test | Water | ◯ | ◯ | ◯ | ◯ | ◯ | ◯ | ◯ | ◯ | ◯ | ◯ | ◯ | ◯ | ◯ | X | ◯ | X | X | ◯ | X |
| result of coated | resistance | | | | | | | | | | | | | | | | | | | |
| test samples (3) | Finished effect | ◯ | ◯ | ◯ | ◯ | ⊙ | ⊙ | ⊙ | ⊙ | ⊙ | ⊙ | ⊙ | ⊙ | ⊙ | X | ◯ | ◯ | ◯ | X | ◯ |

1. A water-based primer composition comprising (A) an aqueous dispersion of modified polyolefin, (B) an aqueous urethane resin and/or aqueous acrylic resin, (C) a pyrazole-blocked polyisocyanate compound and (D) an electrically conducting pigment,
its (C) pyrazole-blocked polyisocyanate compound content being within a range of 5-50 mass % based on the total solid content of the components (A), (B) and (C) and
said electrically conducting pigment (D) containing (D-1) an electrically conducting metal oxide, the content of the electrically conducting pigment (D) being within a range of 50-200 mass parts per 100 mass parts of the total solid resin content in the composition.

2. A water-based primer composition according to claim 1, in which the aqueous dispersion of modified polyolefin (A) is that of unsaturated carboxylic acid- or the acid anhydride-modified polyolefin.

3. A water-based primer composition according to claim 1, in which the aqueous urethane resin is a urethane resin dispersion, and the aqueous acrylic resin contains hydroxyl groups.

4. A water-based primer composition according to claim 1, in which the solid mass ratio of the component (A)/component (B) is within a range of 10/90-70/30.

5. A water-based primer composition according to claim 1, in which the pyrazole-blocked polyisocyanate compound (C) is a 3,5-dimethylpyrazole-blocked polyisocyanate compound.

6. A water-based primer composition according to claim 1, in which the content of the pyrazole-blocked polyisocyanate compound (C) is within a range of 10-40 mass % based on the total solid content of the components (A), (B) and (C).

7. A water-based primer composition according to claim 1, in which the electrically conducting metal oxide (D-1) is a particulate electrically conducting metal oxide.

8. A water-based primer composition according to claim 1, in which the electrically conducting metal oxide (D-1) is an electrically conducting titanium oxide having an electrically conductive layer containing tin oxide and antimony on the surface thereof.

9. A water-based primer composition according to claim 1, in which the content of the electrically conducting pigment (D) is within a range of 70-170 mass parts per 100 mass parts of the total solid resin content of the composition.

10. A water-based primer composition according to claim 1, which further contains a diester compound (E) of a general formula: 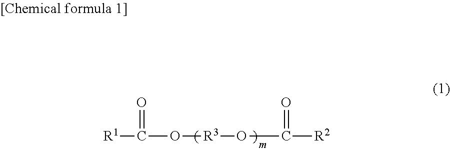
[in the formula, R¹ and R² stand for C₄₋₁₈ hydrocarbon groups independently of each other, R³ stands for a C₂₋₄ alkylene group, and m is an integer of 3-20, said m R³s being same or different]
at a ratio within a range of 1-15 mass parts per 100 mass parts of the total solid content of the components (A), (B) and (C).

11. A coating method which comprises coating the water-based primer composition according to claim 1 onto a plastic substrate surface, and then coating the coated surface with a top coat by electrostatic coating method.

12. A coating method according to claim 11, in which a coloring base paint and a clear paint are sequentially applied as the top coat.

13. A coating method according to claim 12, in which the coloring base paint is a water-based non-conductive coloring base paint.

14. A coating method according to claim 12, in which a water-based non-conductive white base paint and a water-based iridescent color base paint are sequentially applied as the coloring base coat.

15. Articles coated by the method according to claim 11.
